(19) United States
(12) Patent Application Publication
(10) Pub. No.: US 2021/0065120 A1
(43) Pub. Date: Mar. 4, 2021

(54) A SYSTEM AND A METHOD FOR MANAGING THE OPERATIONS OF A COMMERCIAL TRANSPORTATION VEHICLE

(71) Applicant: AVIOVISION, Hasselt (BE)

(72) Inventors: Wim De Munck, Hasselt (BE); Tom De Winne, Hasselt (BE); Kris Van Den Bergh, Hasselt (BE)

(73) Assignee: AVIOVISION, Hasselt (DE)

(21) Appl. No.: 16/644,787

(22) PCT Filed: Sep. 6, 2017
(86) PCT No.: PCT/EP2017/072384

§ 371 Date: Mar. 5, 2020

(51) Int. Cl. G06Q 10/10; G06Q 50/30; G06Q 30/00; G06Q 10/06; G06Q 50/00; H04L 29/06; G06F 16/29; H04L 12/58

(52) U.S. Cl. CPC G06Q 10/103; G06Q 50/30; G06Q 30/0185; G06Q 10/105; G06Q 10/06315; G06F 3/0482; G06Q 50/01; H04L 63/105; G06F 16/29; H04L 51/36; G06Q 2240/00; G06Q 10/063112

(57) ABSTRACT

A system for managing the operations of a commercial transport vehicle for a selected journey leg, wherein a qualified registered user can prepare a vehicle operations plan pertaining to a selected journey leg through a vehicle operations planning tool displayed via a GUI running on a client application based on at least one configuration file associated with the qualified registered user's qualification type and the selected journey leg retrieved by a calling module. The system further comprises a notification module configured for extracting the values assigned to the vehicle operations plan by the qualified registered user and further configured for selectively notifying qualified registered users linked to the selected journey leg and concerned with the extracted values.

A system and a method for managing the operations of a commercial transportation vehicle

### TECHNICAL FIELD

The present invention relates to a system and a method for managing the operations of a commercial transportation vehicle for a selected journey comprising at least one leg operated on a predetermined date between predetermined origin and destination locations. More specifically, the present invention provides a system and a method that enables a qualified registered user to manage the operation settings of a specified vehicle, e.g. an aircraft, train, a ship, a car and the like, for a selected journey leg prior to the departure and/or during the journey period.

### BACKGROUND ART

In the transportation sector, and in particular in the aviation industry, preparing a vehicle operations plan for a selected journey is a complicated and time-consuming process that involves a range of considerations that have to be taken into account to ensure the safe transportation of passengers to their destination. The complexity of preparing a vehicle operations plan may further be increased in the event where the journey includes a number of journey legs each operated between a scheduled departure point and a schedules arrival point. In general, the preparation of the vehicle operation plan for a predetermined journey leg starts before the assigned departure date and is continuously updated and re-checked until the completion of the journey leg. A multitude of system users may be involved in managing the different aspects of the vehicle operations plan for a selected journey leg. Therefore, communicating, coordinating and managing the vehicle operation plan among the different users significantly increases the complexity of the process. To correctly complete the vehicle operation tasks, the system users heavily rely on receiving up-to-date and user relevant information from a variety of sources. For example, a pilot relies on receiving up-to-date information relating to the weather conditions and aircraft load to determine the aircraft performance for the different flight phases or determine the amount of fuel required for the specific journey leg. Similarly, an air-traffic operator relies on receiving accurate information relating to the weather condition and air-traffic to determine the available runway and take-off time for the specific journey leg. Moreover, it is important that notifications and updates resulting from the preparation and/or update of a vehicle operation plan from one system user are seamlessly forwarded to the relevant system users and subscribers associated with the selected journey leg. The exchange of notification and vehicle operation plan updates among the different system users further increases the complexity and associated cost.

Existing systems, such as the one described in US20160093217, are mainly focused on providing the pilot with relevant information for preparing a flight plan and for subsequently communicating any updates made to the flight plan to a number of preselected system users. However, such systems are limited with respect to the number and type of users that can collaborate in real time for the preparation of a vehicle operations plan for a journey leg.

Therefore, there is a need to further optimise and improve the process of preparing the vehicle operations plan by the different system users, without compromising the security and reliability of the system.

### DISCLOSURE OF THE INVENTION

It is an aim of the present invention to provide a system and a method for allowing qualified registered users to collaboratively manage operations of a commercial transport vehicle for a predetermined journey leg in a more accurate and less complex manner, so as to increase the transportation safety of the crew and passengers without at the same time compromising the security and reliability of the system.

For reasons of clarity, in the description hereafter, the invention with its effects and advantages will be exemplified for the aviation industry. However, it will be understood that the invention is applicable in an analogous manner in other sectors of the transportation industries involved in the transportation of goods and/or passengers, such as rail, trucking, bus and coach, taxi and private hire, water transport, etc.

The method and system according to the present invention makes use of client terminals that may be configured as mobile terminals, such as tablet computers, smart phones, laptops, etc., or configured as stationary terminal such as a kiosk for ground handlers or a terminal installed at a predetermined location in the transportation vehicle, such as a touch screen in the cockpit of an aircraft or train.

The aim of the present invention is achieved with a system showing the technical characteristics of the first independent claim.

More specifically, a system is provided for managing a vehicle operation plan associated to the operations of a commercial transport vehicle for a selected journey leg, via a central operation management platform, which is accessible to qualified registered users through a client application installed in a client terminal, such as the ones previously discussed. To this end, the system is provided with a central operations management platform, which is operatively coupled, via a communication network, to a database module comprising at least three repositories. The data stored in the different repositories of the database module may be maintained by an administrator of the system. The first repository comprises a list of registered users, each associated with a user security identifier and a qualification user type at least defining the role, authorization level, and type of vehicle operations assigned to each qualified registered user. For example, a registered user associated with the qualification user type “pilot”, would be assigned a higher authorization level for managing and adapting the settings of a vehicle operations plan, as compared to a registered user assigned the qualification user type “crew”. The second repository comprises a set of journey legs, each associated with a plurality of registered users from the first repository and a transportation vehicle. For example, the journey legs stored in the second repository may be associated with transportation vehicle data, which transportation vehicle data may comprise information related to the transportation vehicle type e.g. Airbus A320, and a unique transportation vehicle identifier such as an aircraft tail number. The second repository may be configured as a relational database holding information about the journey legs to be operated and the transportation vehicles and personnel assigned to each journey leg. For example, the journey leg with origin and destination (O&D) “Paris to London” on a given travel date would be assigned a team of registered users, with a diverse range of qualification user types, e.g. pilot, crew, controller, maintenance crew, catering, etc., which is operated by an “Airbus 320” transportation vehicle type identified by tail number “OOAAV”. The third repository comprises a plurality of vehicle configuration files each associated with a journey leg from the second repository and a predetermined qualification user type from the first repository, each configuration file defining at least a set of configuration settings for generating a vehicle operation plan. The system is provided with a plurality of client terminals each operatively coupled, via a communication network, to the central operations management platform. The terminals are user operated and are configured for running a client application, which may be preinstalled on the client terminal or in a remote server, in which case the application may be accessed via an internet browser. The client application is arranged for providing a registered user from the first repository having a predetermined qualification user type, via a Graphic User Interface (GUI) of the client terminal, a vehicle operations planning tool, which is arranged for interacting with the qualified registered user for the adaptation of a vehicle operations plan for a selected journey leg. The vehicle operations planning tool being configured for providing the qualified registered user with an interactive vehicle operations plan provided with vehicle operations plan data comprising at least a set of user modifiable input parameters relating to the vehicle operations of the specific commercial transport vehicle associated with the selected journey leg and qualification user type. The user-modifiable input parameters of the vehicle operation plan are configured based on the selection of at least one configuration file from the third repository. The central operations management platform is provided with a calling module configured, in response to receiving from a client terminal a user request for preparing a vehicle operations plan, for retrieving from respectively the first and second repositories the user security identifier and, for example based on the security identifier, retrieve the journey legs associated with the qualified registered user of the client terminal. The calling module is configured for forwarding the retrieved journey legs to the client application of the client terminal issuing the user request, where they are displayed to the qualified registered user for the selection of a journey leg. The calling module is configured, in response to receiving a selection of a journey leg from the client application, for retrieving at least one corresponding configuration file from the third repository associated with the selected journey leg and the qualification type of the qualified registered user. For example, the calling module may be configured for retrieving a single configuration file associated to the journey leg and registered user qualification type. For example, the single configuration file may be an XML file created by an administrator of the system containing links to a number of sub-configuration files, which may be stored at a location in the database module. For example, each sub-configuration file may be in an computer executable script format, which can be executed by the client application for setting the parameters of a specific section of the vehicle operations plan, e.g. setting the parameters relating to the performance calculations, fuel, weight & balance calculation, and the like. According to embodiments of the present invention, the calling module may be configured for retrieving a set of configuration files associated to the journey leg and registered user qualification type. The set of configuration files, e.g. a set of XML files created by an administrator of the system, may comprise instructions for configuring and/or generating a specific part of the vehicle operations plan, e.g. a weather tab or a performance calculation tab of the interactive vehicle operations plan shown in the GUI of the client terminal. Furthermore, it should be understood that each configuration file in the set of configurations files retrieved by the calling module, may comprise links to a second sect of sub-configuration files, as previously described. The at least one configuration file is forwarded to the client application, for example on the client terminal, together with at least the user modifiable input parameters for at least configuring the set of user modifiable input parameters of the vehicle operations plan provided to the qualified registered user. The client application is for example instructed to generate the vehicle operations plan based on the set of configuration settings defined by the selected at least one configuration file, wherein the set of configuration settings provide instructions to the client application on how to generate the vehicle operations plan using at least the user modifiable input parameters. The central operations management platform comprises a notification module configured, in response to receiving a vehicle operations plan from a client terminal, for extracting the values assigned to the user modifiable input parameters of the vehicle operation plan and accordingly prepare at least one notification comprising information on the extracted values.

The at least one notification is to be the selectively forwarded, via a notification server, to at least one of the remaining qualified registered users, indicated in the second repository as being associated with the selected journey leg

It has been found that the system of the present invention has several advantages compared to existing solutions. Firstly, by providing the system with a database module having separate repositories for storing different types of data, it becomes easier for an administrator to manage and control access to individual parts of the database module. For example, with this database module configuration, an administrator can easily update the content of any of the individual repositories, e.g. by updating qualified registered users associated with the different journey legs in the second repository, without having to update the remaining parts of the database module. Moreover, the administrator can assign different access levels to the data stored in each of the database module repositories, without affecting the functionality and reliability of the system. Further, by providing for each journey leg a vehicle configuration file, which may have been prepared and checked by a relevant authority, the vehicle operations planning tool can be easily and accurately configured with all the necessary information according to the qualification of the registered user operating the client terminal. In this way, the system can retrieve the correct vehicle configuration information linked to the selected journey leg and qualification user type without the interference of the actual user. Therefore, by configuring the vehicle operations plan on the basis of a configuration file, the accuracy of the information presented to the user can be ensured, which significantly increases the transportation safety for the crew and the passengers alike. Additionally, by providing the system with the notification module presented above, it becomes possible to selectively notify the remaining qualified registered users linked to the journey legs depending on the extracted values assigned to user modifiable parameters of the vehicle operation plan. For example, the notification module may extract the values assigned to the vehicle operation plan by a qualified registered user and accordingly prepare a corresponding notification, based on the information extracted from the vehicle operation plan, which is to be selectively notified, based on a preselected parameter e.g. user qualification level or type, at least one of the remaining users linked to the selected journey leg. For example, the notification module may be configured for extracting the values of the user modifiable parameters as validated by the qualified user, which may include changes and/or updates made to the vehicle operation plan with respect to an earlier version, and accordingly notify the qualified registered users concerned with those values and/or changes and/or updates. The notification of users concerned with those values has the advantage that those users do not have to pull the data, as the data is automatically pushed. This has the advantage that the concerned users are rapidly made aware of a validation and/or a change made to the vehicle operations plan that requires their attention without any further intervention by the user. As a result, delays and errors can be greatly minimised, which ultimately leads to an increase in the safety of the transportation vehicle. The selective notification characteristic of the notification module has the advantage of significantly reducing the amount of information to be transferred via the communication network while at the same time enhancing the integrity and security of the system. This is because the notification module is configured for identifying and notifying only the qualified registered users concerned with the values extracted from the vehicle operations plan, resulting in a reduction of the notification messages sent over the communication network and thus a reduction of the data being transferred. For example, in the case where the pilot of the aircraft decides, based on new weather information, to amend the values of the user modifiable input parameters of the vehicle operation plan related to fuel with respect to an earlier version of the vehicle operations plan, then the notification module may extract the changes made to an earlier version of the vehicle operation plan and accordingly only forward the notification to the qualified registered users associated with the changes, e.g. a ground crew members in charge of fuelling. Furthermore, because the information shared is only accessible by the selected qualified registered users, while it remains private from the remaining users, the system security is significantly enhanced. Furthermore, the privacy of the users of the system is increased as notifications are forwarded only to those qualified registered users directly concerned with the notification for example based on the registered user's qualification type. This alleviates for example the risk that sensitive or confidential information is spread to persons not qualified for handling that information.

In an embodiment of the present invention, the notification module is configured for selecting the registered users to be notified based at least on the qualification type of each registered user associated with the selected journey leg and the values assigned by the qualified registered user to the user modifiable parameters of the vehicle operations plan. In this way, it is ensured that only the registered users having the correct qualification type associated with the extracted values are notified. Therefore, the relevancy and accuracy of the information presented to each qualified registered user linked to the selected journey leg are significantly increased. The selection of the qualified registered users to be notified of the vehicle operation plan may prevent the erroneous notification of registered users, which may lead to a misunderstanding of the notification issued that can consequently compromise the transportation safety and security of the information shared. Furthermore, by selecting the qualified registered users to be notified according to the values assigned and/or the changes made to the vehicle operation plan, may significantly reduce the amount of data to be transferred via the communication network, which may prevent overloading of the network and may reduce the bandwidth requirements of the communication link. For example, in the case, where the pilot has adjusted the fuel and load values of an aircraft operation plan, while maintained the values of the remaining user modifiable parameters, the notification module may retrieve the linked qualified registered users associated with the changes made to the vehicle operations plan e.g. ground crew members in charge of fuelling and/or redistributing the load of the transport vehicle for the given journey leg, and accordingly issuing the corresponding notifications.

In an embodiment of the present invention, the notification module is configured for personalising the notifications issued to each of the selected registered users according to their qualification user type. In this way, the accuracy and relevancy of the information presented to each linked user are further increased, leading to an increased transportation safety. The personalisation of the notifications issued may relate to how the information is communicated and displayed in the terminal of each qualified registered user. For example, depending on the qualification type the registered users may be set up in the system to receive notifications via different communication channels e.g. text message, email, call, and the like, and in a predetermined format e.g. voice message, text, animation, video, and the like. Furthermore, the personalization may relate to the amount and type of information communicated to each of the qualified registered users. For example, depending on the qualification type of each registered user, certain users may receive notifications containing precise instructions e.g. increase fuel by value “X”, while others may receive more detailed notification messages containing additional information. As a result of the personalization, the notifications issued can be more accurately targeted to the requirements and authorization level of each qualified registered user, thus further contributing to increasing the security of the information shared between the different qualified registered users.

According to an embodiment of the present invention, the notification module is configured for selecting the notifications to be pushed to each of the selected qualified registered users from a user notification Look Up Table (LUT), which may be stored in the first repository. The LUT comprises a set of instructions indicating the type of notifications to be pushed to each qualified registered user according to their qualification user type and changes made to the vehicle operations plan. This embodiment enables an easy adaptation of the types of notifications to be pushed to each qualified registered user as a function of the possible type of changes made to the vehicle operations plan. In this way, an administrator can easily adapt the content of the LUT to reflect changes associated with the number and type of qualified registered users and changes associated with the type of vehicle operation plan concerned. As a result, the system of the present invention can be easily adapted to the requirements of a variety of applications in the transportation sector e.g. aviation, logistic, shipping, and the like, without the need for adapting the architecture of the system. In an embodiment of the present invention, the user may adjust the notification preferences in the client application and/or the system for receiving and forwarding notifications. For example by acting as an administrator of the system and adapting, according to his authorization level associated to his qualification, the content of the LUT such as to receive for example fewer or more notifications. For example a pilot may be authorized to adapt the LUT such as to receive all notifications relating to his flight including notifications that are of no direct concern to him or to block notifications that are of no concern to him such as changes in meal plans notified to the caterer and the cabin crew.

According to an embodiment of the present invention the notifications issued comprise instructions for executing at least one operational task. This embodiment enables the personalization of the operational tasks to be performed by the qualified registered users linked to the journey leg. The personalization may be based on the changes made on the vehicle operation plan. For example, a notification module having received a vehicle operation plan containing fuel and load distribution adjustments, would instruct the notification server to issue a personalised operational task to each of the qualified registered users associated with the tasks to be executed. As a result, the qualified registered user responsible for fuelling may receive a different notification from the register user responsible for loading the transportation vehicle. In this way, the relevancy and accuracy of the instructions received by each qualified registered users for executing a specific task is significantly increased, leading to the prevention of mistakes that may compromise transportation safety.

According to an embodiment of the present invention, the notification module is configured for deriving the at least one operational task from at least the values assigned to the set of user modifiable input parameters of the received vehicle operation plan. The notification module may extract the values of the user modifiable input parameters, and based on retrieving instructions from the user notification Look Up Table (LUT) associated with the extracted values, may derive an operational task to be executed by a registered user having a relevant qualification type. For example, the notification module may extract from the set of user modifiable input parameters the fuel quantity, and accordingly, derive an operation task, e.g. fill aircraft with “X” amount of fuel, which is sent to a registered user having an appropriated qualification type for executing the derived operation task, e.g. a fuel handler. This embodiment has the advantage of providing specific instructions to the qualified registered users concerned with the changes made to the user modifiable input parameters; thereby significantly reducing the chances of a mistake to be made that may have detrimental effects on the safety of the vehicle.

According to an embodiment of the present invention, the notification module is configured for deriving the at least one user operational task from at least historical information associated with the selected journey leg and vehicle, wherein the historical information are retrieved from a historical information database. This embodiment has the advantage that of increasing the relevancy and accuracy of the operational tasks by taking into account historical remarks made by qualified registered users concerning the same vehicle and journey leg operated under similar conditions, e.g. the same date, in the same season, in similar weather conditions, and the like.

According to an embodiment of the present invention, the notifications issued by the notification module are to be displayed on the GUI of the client terminals of each of the selected qualified registered users to be notified. The display of the notification on the GUI of the clients' terminals of each of the selected users, for example as a pop-up message or as a notification indication, has the advantage that the selected users are made aware of the receipt of notification, enabling their quick response.

According to an embodiment of the present invention, the database module comprises a fourth repository storing a set of first data structures each storing journey information associated with a predetermined journey leg, and a set of second data structures each storing configuration information of a predetermined transportation vehicle. For example, the first data structure may store information related to the weather, information related to the passengers, the cargo load to be carried on the selected journey leg, and the like. The second data structure may for example contain information related to the transportation vehicle, such as performance tables, load and fuel, vehicle type manuals, and the like. It has been found that the storage of two distinct data structures in the fourth repository has the advantage that the data can be easily managed, e.g. accessed, updated or changed with minimal effort, thereby ensuring the relevancy, accuracy and validity of the stored data, which is to be used by the qualified registered users for making critical decisions.

According to an embodiment of the present invention, the calling module is configured, in response to retrieving the configuration file associated with the selected journey leg and qualification type of the qualified registered user, for retrieving based on the configuration file a set of data from the first and second data structures from the fourth repository to be provided to the client application together with the configuration file for the generation of the vehicle operations plan. The configuration file, for example, comprises instructions for the calling module to retrieve data from the fourth repository based on the qualification type of registered user and the journey associated with the configuration file. In this way, the qualified registered user is presented with a readily available set of relevant data that can be used to make critical changes to the vehicle operation plan, e.g. change the amount of fuel based on the weather information received. As a result, the process of preparing a vehicle operation plan can be greatly simplified, since the relevant information is automatically selected from the storage module without the involvement of the user. Furthermore, since the relevancy, accuracy and validity of the information presented to the user can be ensured by the system, mistakes made in the vehicle operation plan can be prevented, which further increases the transportation safety.

According to an embodiment of the present invention, the vehicle operations planning tool being configured for providing the qualified registered user with an interactive vehicle operations plan provided with vehicle operations plan data comprising at least a set of user modifiable input parameters and static data relating to the vehicle operations of the specific commercial transport vehicle associated with the selected journey leg and qualification user type. This embodiment has the advantage that the qualified registered user is presented an interactive vehicle operations plan comprising user modifiable input parameters for example a pilot being presented with fuel amounts as well as static data for example the pilot being presented with weather data for the given journey leg. A vehicle operations planning tool presenting a vehicle operations plan comprising user modifiable input parameters as well as static data allows the qualified registered user to more easily modify the user modifiable input parameters in the vehicle operations plan tool by relying on the context provided by the static data.

According to an embodiment of the present invention, each of the different types of data stored in each of the repositories of the database module is assigned a unique time-of-expiration identifier indicating the period for which the data is valid. The assignment of a unique time-of expiration identifier to each of the different types of data, which may extend to every data entry in each of the repositories of the database module, may provide the advantage of easily assessing the age and validity of the stored data. According to an embodiment of the present invention, the client application comprises a data validation module configured for determining, based on the time-of-expiration identifier, the validity of the data displayed via the GUI to the client terminal of the qualified registered user. According to an embodiment of the present invention, the data validation module is configured, upon detecting that invalid and/or incomplete data is displayed on the GUI of the client terminal, for issuing an alert signal to the qualified registered user indicating the type of data that needs be updated. The data validation module has the advantage of warning the qualified registered user regarding the validity of the data presented to him, thereby assisting the qualified registered user in making well-informed changes to the vehicle operations plan thus increasing the safety of the system. The data validation module, may further precisely indicate to the user the type of data that need to be updated, which may be performed by downloading the updated data from a server. In this way, the user is always aware of the validity of the data presented to him/her, and thus mistakes made due to the use of irrelevant data are minimised.

According to an embodiment of the present invention, the data validation module is configured for preventing the qualified registered user for preparing the vehicle operations plan while the alert signal is displayed on the GUI of the client terminal. It has been found that preventing the user from modifying the operational plan in the presence of the alert signal has the advantage of increasing the transportation safety.

According to an embodiment of the present invention, the central operations management platform comprises a database update module configured for updating at predetermined time intervals the data stored in each of the database module repositories with data retrieved from at least one third party database. The database update module has the advantage of providing the database module with up-to-date data from content specific third party providers such as a weather forecasting the third party can provide the fourth repository of the database module with up-to-date weather data associated with a given geographical location at a given time period linked in the fourth repository to journey legs having a trajectory between its origin and destination at the time of the journey corresponding to the geographical location at the given period of the weather data.

According to an embodiment of the present invention, the database update module is configured for updating the data stored in the database module at predetermined time intervals, which are for example calculated individually for each type of data stored according to the assigned time-of-expiration identifier. According to an embodiment of the present invention, the database update module is configured for updating the different data types at the request of the user. The database update module configured for updating automatically the data at predetermined time intervals has the advantage of ensuring that up-to-date data is present in the database module without requiring the interaction of the qualified registered users or administrators. The database update module configured for additionally updating the data in the database module at the request of the user has the advantage of allowing the qualified registered user to request the most up-to-date data when he needs that data. Furthermore, by updating the database at the user request had the advantage of limiting the amount of data to be transferred between the database module and the third party providers, thus contributing to the reduction of the bandwidth requirements of the communication network.

According to an embodiment of the present invention, the client application comprises a calculation module configured for calculating, based on data forwarded by the calling module for example vehicle operations plan data and computation scripts relating to a specific task for a specific transport vehicle, the initial values of at least some of the set of user modifiable input parameters of the vehicle operations plan provided to the qualified registered user via the vehicle operations planning tool generated based on the set of configuration settings defined by the selected configuration file. The calculation module has the advantage of providing the initial values of user modifiable input parameters which provide an estimate of the value the user modifiable input parameters should have and provides the qualified registered user with a starting point to make his changes to the user modifiable input parameters. As a result, the process of preparing the vehicle operation plan may be greatly simplified.

According to an embodiment of the present invention, the central operations management platform comprises a user messaging module configured for enabling the registered users for example qualified registered users defined in the list of the first repository for selectively exchanging communication messages via the client application, for example, running on each of the client terminals. The user messaging module has the advantage that qualified registered users for example linked to each other by the journey leg and transport vehicle as defined in the second repository can communicate in near-real time with each other for example to confirm or discuss the changes made to the user modifiable input parameters. With the use of the messaging module, information related to the journey can be readily communicated in near-real time between the selected qualified registered users, thereby enabling for the qualified registered user to become quickly aware of events that may impact the vehicle operation plan. For example, the traffic controller may issue a warning that impacts the scheduled time or journey trajectory due to adverse weather conditions, thus enabling the pilot to accordingly change the vehicle operation plan. Furthermore, the selective communication function of the messaging module ensures that sensitive information can be shared privately between qualified registered users, thus greatly increasing the security of the system.

According to an embodiment of the present invention the user messaging module is configured for operating in either private mode, whereby a first register user selectively exchanges communication messages with at least one second qualified registered user selected from the list of qualified registered users, or in a public mode, whereby communication messages send by a first qualified registered user are visible to all qualified registered users. The possibility to operate either in private mode or public mode enables the user to select the optimal mode according to the situation such as enabling a qualified registered user to operate in private mode in case of sensitive or confidential information or such as enabling a qualified registered user for example a pilot to brief his entire staff without having to brief every user in the staff individually.

According to an embodiment of the present invention the central operations management platform comprises a user registration module configured for registering, at the request of a qualified registered user having an appropriate authorisation level, an additional user in the list of qualified registered users of the first and second repositories of the database module, the user registration module for example being configured for selectively assigning a registration expiration identifier to the additional user, indicating a predetermined period for maintaining the additional user in the list of registered users. The user registration module has the advantage of enabling a registered user to quickly add a temporary staff member to the system for example to add a contractor such a third party member merely requiring access to the system for a limited amount of time for example a day in order to perform a quality audit of the transport vehicle. A temporary user may for example be registered by a qualified registered user by visual identification of the temporary user or upon scanning of a QR badge of the temporary user for example indicating that the user is qualified for a particular task. The qualified registered user may further be able to add a user qualification type to the temporarily registered user, such as a GE-engine maintenance engineer receiving as a user qualification type ‘GE engine maintenance engineer’, thereby for example restricting the notifications received by the temporarily user to notifications relating to the maintenance of a GE engine for example pertaining to a particular transport vehicle.

According to an embodiment of the present invention the system comprises at least one administrator terminal operatively coupled to the database module, the administrator module comprising a GUI arranged for allowing an administrator user to access and to adapt the data stored in the database module. The system comprising at least one administrator terminal has the advantage of enabling an administrator to easily modify data stored in the database module.

According to an embodiment of the present invention the commercial vehicle transport is an aircraft, train, bus, ship and truck. The invention is applicable in an analogous manner in other sectors of the transportation industries involved in the transportation of goods and/or passengers, such as rail, trucking, bus and coach, taxi and private hire, water transport, etc

According to an embodiment of the present invention the qualified registered user are any one of a pilot, crew member, ground operating staff, airline operator, dispatcher, air traffic controller, and the like, each for example being associated with a qualification user type. According to an embodiment of the present invention the client application may be configured according to the qualification user type of the registered user. For example, the GUI of the client application may be configured differently for a registered users having a qualification type “pilot” compared to a registered user having the qualification type “crew”. The qualified registered user can for example install on a client terminal a client application or a link to a client application via a remote server corresponding to his qualification user type for example a specific client application dedicated to maintenance engineers or train conductors. Alternatively, the qualified registered user can for example install a generic client application or a link to a generic client application on a remote server, wherein the registered user is required to indicate his qualified user type upon activation of the client application for example through a login procedure. According to an embodiment of the present invention the client application is configured for adapting the vehicle operations planning tool according to the qualification user type of the registered user operating the client application.

According to an embodiment of the present invention at least one of the plurality of client terminal is part of an electronic device comprising an Electronic Flight Bag (EFB) software application.

It is another aim of the present invention to provide a computer implemented method for collaboratively managing the operations of a commercial transport vehicle for a predetermined journey leg in a more accurate and less complex manner, so as to increase the transportation safety of the crew and passengers without at the same time compromising the security and reliability of the system.

This aim is achieved by a computer implemented method comprising the steps of:

providing a central operations management platform operatively coupled, via a communication network, to a database module comprising

a first repository comprising a list of registered users, each associated with a qualification user type at least defining the role, authorisation level, and type of vehicle operations assigned to each qualified registered user,

a second repository comprising a set of journey legs of a transportation vehicle, wherein each journey leg is associated with a plurality of qualified registered users from the first repository, and

a third repository comprising a plurality of vehicle configuration files each associated with a journey leg from the second repository and a predetermined qualification user type from the first repository, each configuration file defining at least a set of configuration settings for a vehicle operation plan;

providing a plurality of client terminals each operatively coupled, via a communication network, to the central operations management platform, each client terminal being provided with a client application configured when running for executing the steps of
providing to a qualified registered user from the first repository having a predetermined qualification user type, via a Graphic User Interface (GUI) of the client terminal, a vehicle operations planning tool configured for providing to the qualified registered user a vehicle operations plan comprising at least a set of user modifiable input parameters relating to the vehicle operation settings of the specific commercial transport vehicle associated with the selected journey leg, which user modifiable input parameters of the vehicle operation plan are defined based on the selection of at least one configuration file from the third repository; and
preparing the vehicle operations plan for the selected journey leg;
wherein the step of preparing the vehicle operations plan comprises the steps of:
in response to receiving at the central operation management platform a user request for preparing a vehicle operations plan, retrieving by means of a calling module from respectively the first and second repositories the user qualification type and the journey legs associated with the qualified registered user of the client terminal used to issue the user request;
forwarding by means of the calling module the retrieved journey legs to the client application of the client terminal used to issue the user request to be displayed to the qualified registered user, via the GUI, for the selection of a journey leg, wherein the calling module is configured, in response to receiving a selection of a journey leg, from the client application, for performing the steps of:
retrieving by means of the calling module at least one corresponding configuration file from the third repository associated with the selected journey leg and the qualification type of the qualified registered user; and
forwarding by means of the calling module the retrieved at least one configuration file together with at least the user modifiable input parameters to the client application of the client terminal for at least configuring the set of user modifiable input parameters of the vehicle operations plan provided to qualified registered user; and
   for selectively notifying by means of a notification module at least one the remaining qualified registered users, indicated in the second repository as being associated with the selected journey leg, wherein the notification module is configured, in response to receiving a vehicle operations plan from a client terminal, for at least performing the steps of:
extracting from the vehicle operation plan the values assigned to the user modifiable input parameters
preparing at least one notification comprising information on the extracted values, and
selectively forwarding the at least one notification, via a notification server, to at least one of the remaining registered users, indicated in the second repository as being associated with the selected journey leg.

According to an embodiment of the present invention the step of preparing the vehicle operations plan comprises the steps of:
updating vehicle and journey leg related data presented to the user;
modifying the value of at least one of the input parameters of the vehicle operation plan; and
committing the vehicle operations plan for execution to the central operations management platform.

It is another object of the present invention to provide a computer program product for collaboratively managing the operations of a commercial transport vehicle for a predetermined journey leg in a more accurate and less complex manner.

This object is achieved by providing a computer program product directly loadable into a memory of a computing device, comprising software code portions for performing the steps of the computer implemented method as presented in the second independent claim.

### BRIEF DESCRIPTION OF THE DRAWINGS

The invention will be further elucidated by means of the following description and the appended figures.

FIG. 1 shows an example of the system according to the present invention.

FIG. 2 shows an exemplified flow chart of the interactions between the different components of the system when preparing a vehicle operations plan according to embodiments of the present invention.

FIG. 3 shows an overview of an example of the system describe in FIG. 1 according to embodiments of the present invention.

FIG. 4 shows an example of the central operations management platform according to embodiments of the present invention.

FIGS. 5 to 7 show an example of client terminal comprising a client application, a graphical user interface and a communication interface according to embodiments of the present invention.

FIGS. 8 to 10 show an example of a Graphical User Interface (GUI) running on a client terminal according to embodiments of the present invention.

FIGS. 11a and 11b show examples of work flows for managing the operations of a transportation vehicle according to embodiments of the present invention.

FIG. 12 shows an exemplified implementation of a system according to the present invention.

FIG. 13 shows a further example of a Graphical User Interface (GUI).

### MODES FOR CARRYING OUT THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Furthermore, the various embodiments, although referred to as “preferred” are to be construed as exemplary manners in which the invention may be implemented rather than as limiting the scope of the invention.

The term “comprising”, used in the claims, should not be interpreted as being restricted to the elements or steps listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising A and B” should not be limited to devices consisting only of components A and B, rather with respect to the present invention, the only enumerated components of the device are A and B, and further the claim should be interpreted as including equivalents of those components.

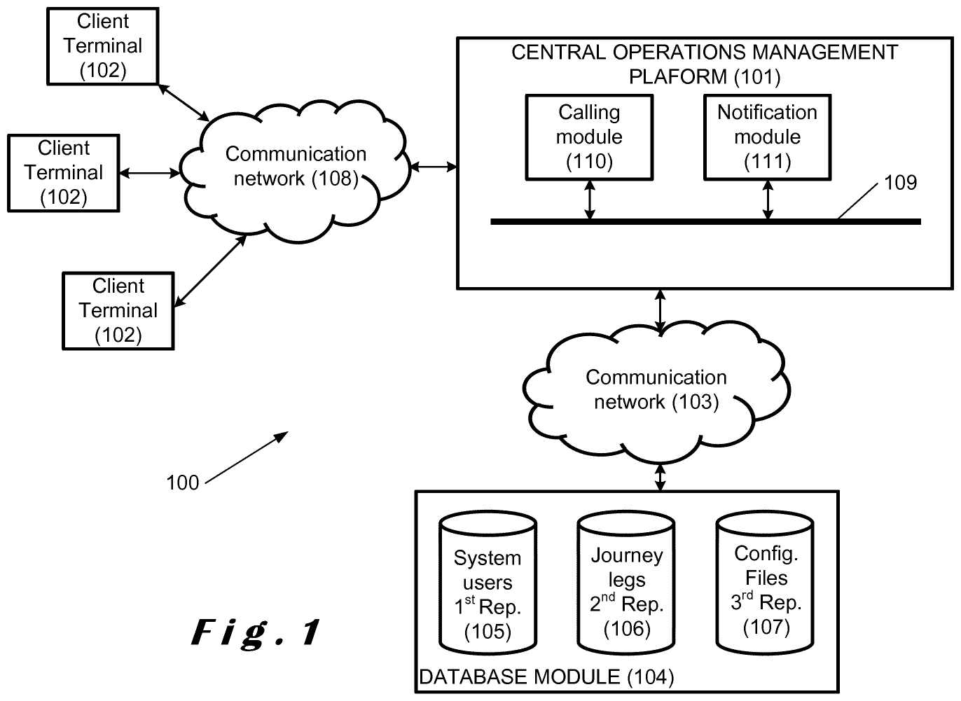

The system and method for managing the operations of a commercial transport vehicle for a selected journey leg according to embodiments of the present invention will now be described with references to the examples shown in FIGS. 1 to 12.

As used herein, the term “operations of a transportation vehicle” or “vehicle operations” may refer to operational tasks to be performed and/or set by a qualified registered user in order to successfully operate a transportation vehicle such as an airplane. For example, in the aviation industry the operational tasks to be executed and/or may include the provision of fuel to the airplane by a ground crew, the setting of airplane performance parameters by a pilot, the scheduling of a runway by a dispatcher, and the like.

As used herein, the term “journey leg” may refer to a journey to be made by the transport vehicle between a given origin and a departure on a given date.

As used herein, the term “qualified registered user”, may refer to users of the system of the present invention, such as the ground crew, the pilot and the dispatcher that can prepare and/or make changes to the vehicle operation plan of the transportation vehicle according to their qualification type and authorisation level. It should be noted, that with the system of the present invention it is possible to register users, by means of an existing qualification user having the appropriate qualification type, that can temporarily have access to the system and being associated with a qualification type and authorisation level.

As used herein, the term “qualification type” of a registered user may refer to the role, authorization level a user for performing a certain operational task, and type of vehicle operation tasks associated to each of qualified registered user. For example, an airline operator may have a qualification type allowing him/her to fully access the operational settings of the vehicle operation plan, while a pilot may have a qualification type that allows only a partial access to the operational settings of the vehicle operations plan, e.g. manipulation of the aircraft performance values, fuel, load distribution, etc.

As used herein, the terms “database” and “repository” are intended to mean one or more storage media including but not limited to servers, computers, hard drives, cloud services, etc. that are capable of storing data in a predetermined format that is readily available to the system according to embodiments of the present invention.

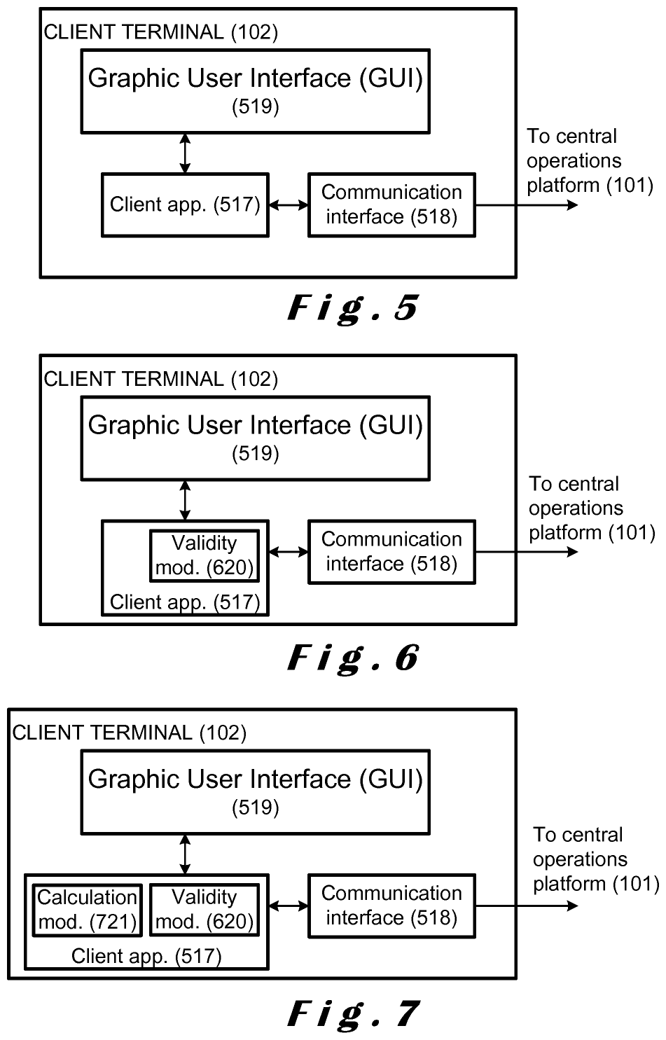

FIG. 1 shows an example of a system 100 for managing the operations of a commercial transportation vehicle for a selected journey leg according to embodiments of the present invention. The system 100 is provided for managing a vehicle operation plan associated to the operations of a commercial transport vehicle for a selected journey leg, via a central operation management platform 101. The vehicle operations plan is accessible by a number of qualified registered users through a client application 517 (shown for example on FIG. 5), which may be for example installed on a number of client terminal 102a, 102b, 102c. The client terminals 102a, 102b, 102c may be configured as mobile terminals, such as table computers, smart phones, laptops, etc., or alternatively nay be configured as stationary terminal installed at a predetermined location in the transportation vehicle, such as a touch screen in the cockpit of an aircraft. The central operations management platform 101 of the system 100 may be operatively coupled, via a communication network 103, to a database module 104, which may be provided with a number of data repositories. The data stored in the different repositories of the database module 104 may be maintained by an administrator of the system. For example, as shown in FIG. 1, the database module 104 may be provided with three repositories 105, 106 and 107. The first repository 105 may comprise a list of qualified registered users, each associated with user security identifier and a qualification user type. The qualification type of each qualified registered user may define the role, authorization level, and type of vehicle operations assigned to each qualified registered user. For example, a qualified registered user associated with the qualification user type “pilot”, would be assigned a higher authorization level for managing and adapting the settings of a vehicle operations plan, as compared to a qualified registered user assigned the qualification user type “crew”. The second repository 106 may comprise a set of journey legs, each associated with a plurality of qualified registered users from the first repository and a transportation vehicle comprising the transportation vehicle type and an unique transportation vehicle identifier. The second repository 106 may be configured as a relational database holding information about the journey legs to be operated and the transportation vehicles and personnel assigned to each journey leg. The third repository 107 may comprise a plurality of vehicle configuration files each associated with a journey leg from the second repository 106 and a predetermined qualification user type from the first repository 105. Each configuration file may define at least a set of configuration settings for generating a vehicle operation plan. According to embodiments of the present invention, a plurality of client terminals 102 may be operatively coupled, via a communication network 108, to the central operations management platform 101. Each client terminals 102 may be user operated and may be configured for running a client application 517, which may be preinstalled on the client terminal 102. The client application 517 is arranged for providing a qualified registered user from the first repository 105 having a predetermined qualification user type, via a Graphic User Interface (GUI) 519 of the client terminal 102, a vehicle operations planning tool, which is arranged for interacting with the qualified registered user for the adaptation of a vehicle operations plan for a selected journey leg. The vehicle operations planning tool being configured for providing the qualified registered user with an interactive vehicle operations plan provided with vehicle operations plan data, which may comprise at least a set of static data and a set of user modifiable input parameters relating to the vehicle operations of the specific commercial transport vehicle associated with the selected journey leg and qualification user type. The vehicle operations plan data such as the user-modifiable input parameters of the vehicle operation plan are configured based on the selection of a configuration file from the third repository 107 and enable the qualified registered user to make adaptations to the vehicle operations plan. The central operations management platform 101 comprises at least a calling module 110 and a notification module 111 connected to one another via a communication bus 109. Each of the calling module 110 and a notification module 111 may be configured for retrieving and transmitting data via a communication network 103 from/to the databases provided in the database module 104, and via communication network 108 from/to the client terminals 102. As used herein, the term ‘module’ refers to any type of computing device such as a server, a computer, a cloud service and the like, configured for processing and routing data.

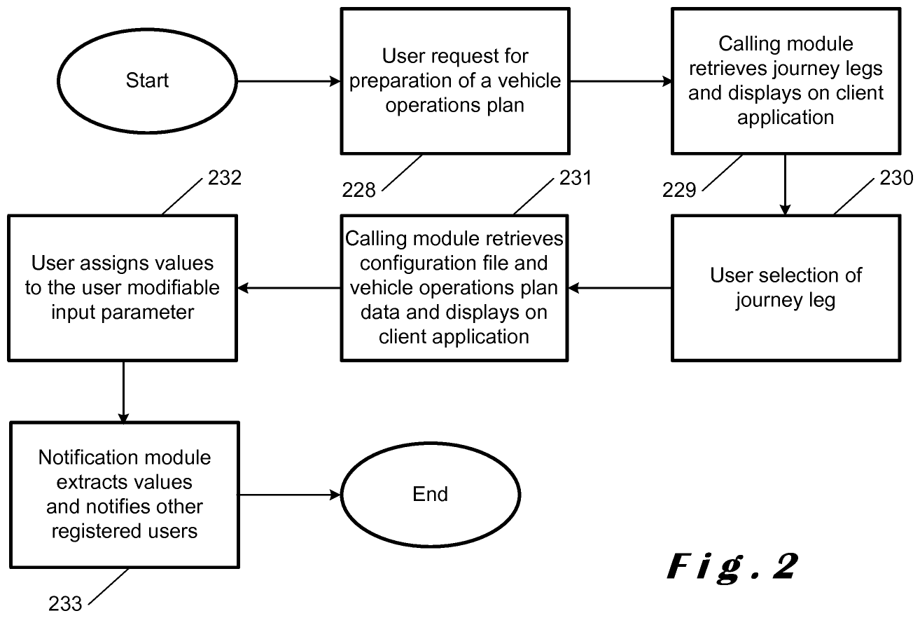

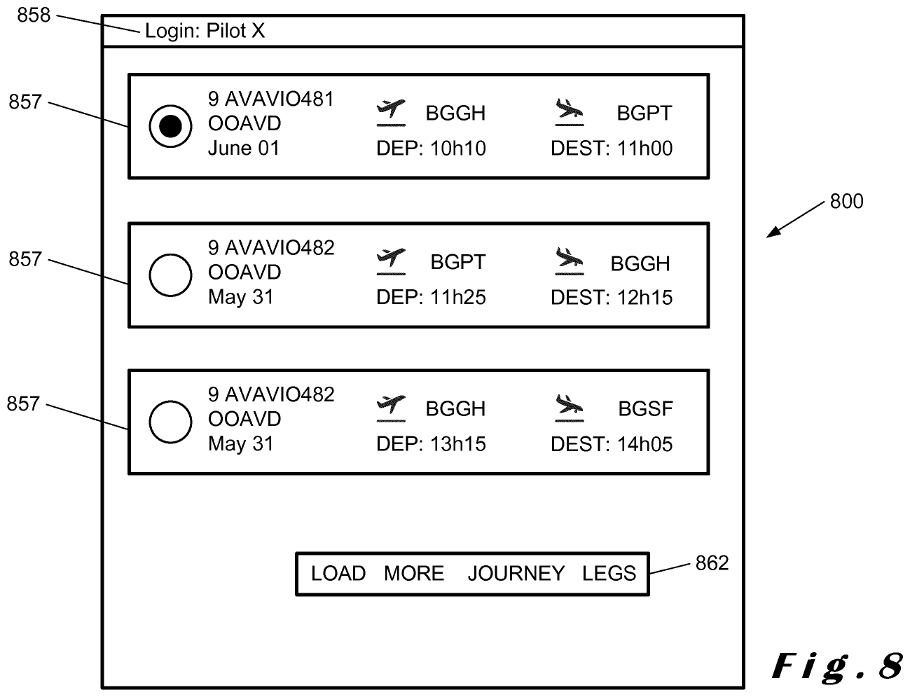

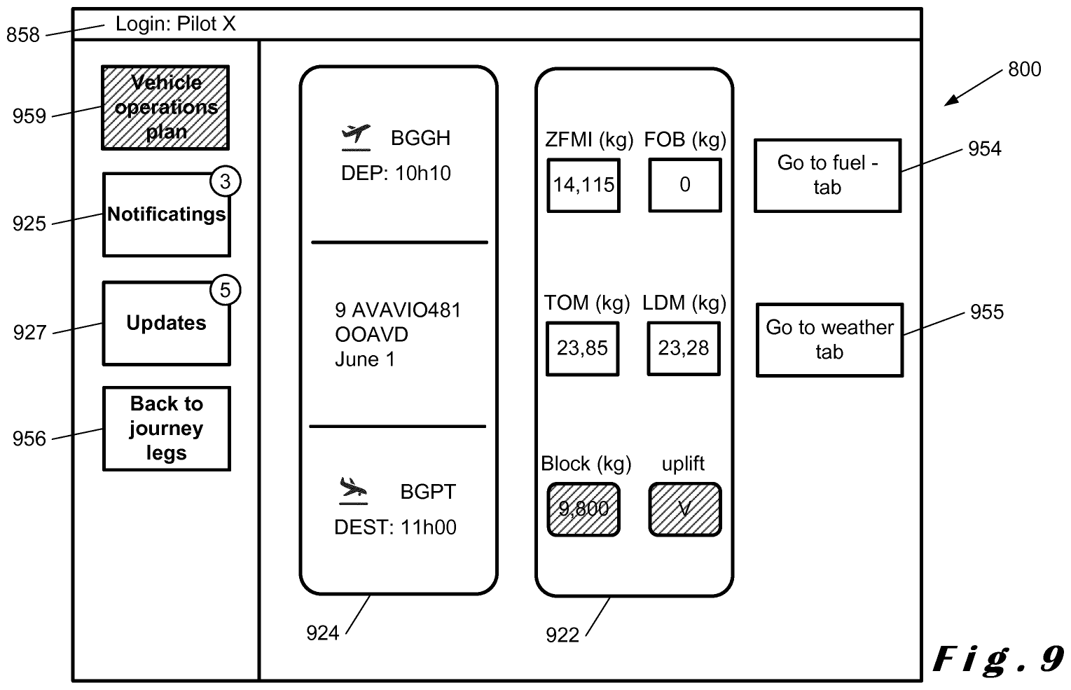

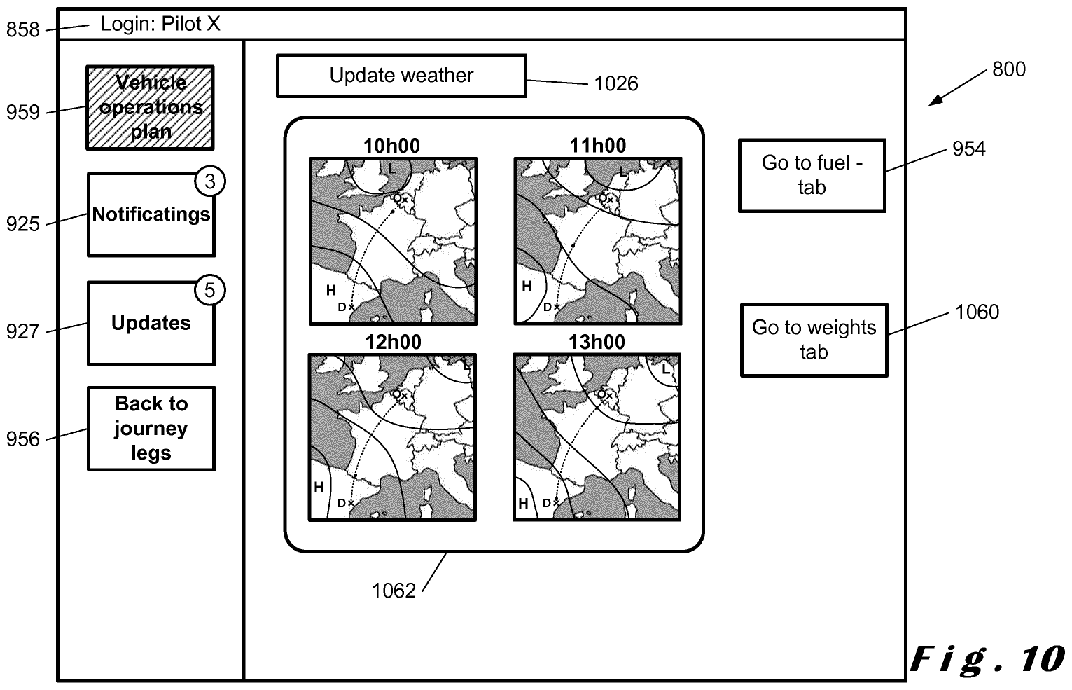

FIG. 2 shows an example of a flow chart representing the operation of the system 100 upon a qualified registered user issuing a request for managing the operations of a transport vehicle. As shown in FIG. 2, the process for managing and/or preparing a vehicle operations plan may start at step 228 with a pilot issuing a request via the client application 517 to system 100 for preparing a vehicle operations plan for an upcoming flight by logging-in in the client application 517 through his client terminal 102. The system 100 receives the request of the pilot at the central operation management platform 10, and using the calling module 110 retrieves in step 229 from respectively the first and second repositories 105,106 the user security identifier and the upcoming journey legs associated with the qualified registered user based on the user security identifier. The user security identifier may be a unique number or another identification measure that can be used to identify an individual register user in the system. The calling module 110 is configured for forwarding the retrieved journey legs to the client application 517 of the client terminal 102 issuing the user request, where they are displayed to the qualified registered user for the selection of a journey leg. For example, once logged-in in the system the pilot may receive a list with all upcoming journey legs that have been associated with his/her credentials in the system. FIG. 8 shows an example of a client terminal GUI 519 running the vehicle operations planning tool 800 displaying a set of journey legs 857 to the qualified registered user logged in to the client application 517 such as a pilot named ‘X’ 858. As an illustration, the vehicle operations planning tool shown in FIG. 8 shows the selection by the qualified registered user of a journey leg between the airport of Nuuk indicated as BGGH and the airport of Paamiut indicated as BGPT on the 1^{st} of June for a flight with identification number 9AVAV10481, with tail number OOAVD. The qualified registered user logged in into the client application 517 can load more journey legs to make his selection through a journey legs loading box 862. The user can for example load more journey legs in order to prepare the vehicle operations plan of a journey leg taking place further in the future than the journey legs already loaded and presented on the vehicle operations planning tool 800. In step 231, the calling module 110 is configured, in response to receiving a selection of a journey leg from the client application 517 in step 230, for retrieving a corresponding configuration file from the third repository 107 associated with the selected journey leg and the qualification type of the qualified registered user retrieved from the first repository 105. The configuration file is forwarded to the client application 517 together with vehicle operations plan data comprising at least the set of user modifiable input parameters and a set of static data for at least configuring the set of user modifiable input parameters of the vehicle operations plan provided to the qualified registered user. More specifically, the client application 517 is instructed to generate the vehicle operations plan based on the set of configuration settings defined by the selected configuration file, wherein the set of configuration settings provide instructions to the client application 517 on how to generate the vehicle operations plan using the user modifiable input parameters and static data. FIG. 9 shows a practical example of a client terminal GUI wherein the client application 517 displays the vehicle operations planning tool 800 for a pilot named ‘X’ 858, displaying a vehicle operations plan 959 for a selected journey leg between the airport of Nuuk indicated as BGGH and the airport of Paamiut indicated as BGPT for a flight with identification number 9AVAV10481, with tail number OOAVD on the 1st of June. The user modifiable parameters are displayed according to the instructions of the configuration settings defined by the configuration file. As an illustration, the vehicle operations planning tool shown in FIG. 9 shows a GUI wherein the qualified registered user has modified/changed the user modifiable parameters 922 associated to the block weight and uplift. The figure also shows that the qualified registered user has validated the user modifiable input parameters 922 associated to the ZFM weight, the FOB weight, the TOM weight and the LDM weight i.e. has not adapted these values with respect to the initial values for example calculated by the calculation module 721 of the client application 517. The journey leg itself is shown in the vehicle operations planning tool as static data 924 indicating the flight times, O&D and flight number of the journey leg. The vehicle operations tool 800 shown in FIG. 9 also shows tabs to navigate the vehicle operations plan 959 such as a tab 954 opening a fuelling oriented part of the vehicle operations plan 959 and a tab 955 opening a weather oriented part of the vehicle operations plan 959 such as the part shown in FIG. 10. The vehicle operations tool 800 also provides the qualified registered users the option to navigate back to the selection of the journey legs such as shown in FIG. 8, for example through a return button 956. FIG. 10 shows a further practical example of a client terminal GUI wherein the client application 517 displays the vehicle operations planning tool for a pilot, logged in as pilot ‘X’ 858, displaying a vehicle operations plan for a selected journey leg wherein the vehicle operations plan data solely comprises static data in example weather charts 1062 corresponding to the selected journey leg. The vehicle operations plan tool 800 shown in FIG. 10 also provides the qualified registered user with a button to navigate to other parts of the vehicle operations plan 959 such as a tab 1060 relating to aircraft weights such as the part of the vehicle operations plan 959 shown in FIG. 9. In response to receiving a changed or validated vehicle operations plan from a client terminal 102 for example upon the qualified registered user saving the changes he made to the user modifiable input parameters in the vehicle operations plan in step 232, the notifications module 111 extracts in step 233 the values assigned to the user modifiable parameters of the vehicle operation plan and accordingly prepares a notification, which is selectively notified, via a notification server, to at least one of the remaining qualified registered users associated with the selected journey leg. FIGS. 9 and 10 show an example of notification arriving at the notification tab 925 of the vehicle operations planning tool 800. The notification module 111 is configured for selecting the qualified registered users to be notified based at least on the qualification user type of each qualified registered user associated with the selected journey leg and the values assigned by the qualified registered user to the user modifiable parameters of the vehicle operations plan. This may for example be implemented as a look-up table (LUT) stored within the database module 104 where, for each transport vehicle, for example all transport vehicles associated to a given airline company operating under the same airline company policy rules, a LUT is provided matching on the one hand the changes for example type or value of the changes made to the vehicle operations plan, and on the other hand the qualified registered user to be notified. As an example a change in fuel ordering by a pilot should be notified to at least the ground crew responsible for fuelling, whereas no notification should be send to the cabin crew as this change doesn't require an operational task from them.

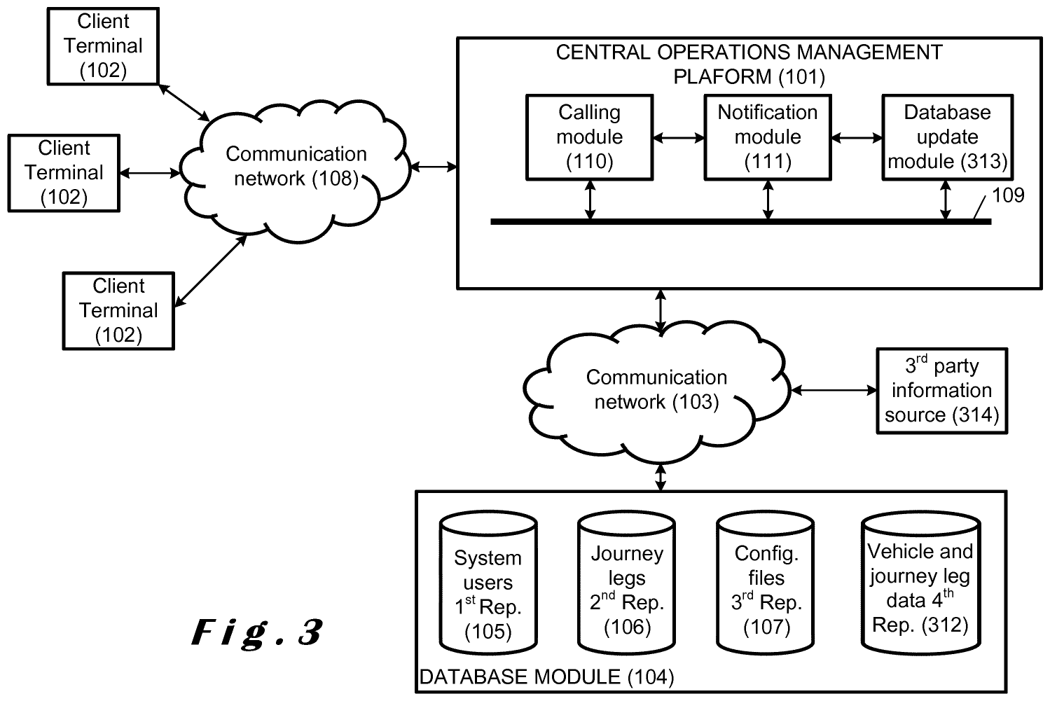

As shown in FIG. 3, the database module 104 of the system 100 as presented in FIG. 1 may be further provided with a fourth repository 312. The fourth repository 312 stores a set of first data structures each storing journey information associated with a predetermined journey leg such as weather data, and a set of second data structures each storing configuration information of a predetermined transportation vehicle for example relating to the transportation vehicle or to a transportation vehicle type such as scripts configured for instructing the client terminal to calculate performance settings such as the required take-off speed of the particular transport vehicle based on context data for example provided by the static data such as aircraft load and weather conditions, aircraft type, specific aircraft features such as specific aircraft load distribution due to specific aircraft fuselage paint or specific aircraft seat distribution etc. The calling module 110 in response to retrieving the configuration file associated with the selected journey leg and qualification type of the qualified registered user, retrieves based on the configuration file a set of vehicle operations plan data from the first and second data structures of the fourth repository 312 to be provided to the client application 517 together with the configuration file for the generation of the vehicle operations plan in the vehicle operations planning tool. The configuration file for example comprises instructions for the calling module 110 to retrieve vehicle operations plan data comprising static data and user modifiable input parameters from the fourth repository 312 based on the qualified registered user and the journey leg associated to the configuration file. Furthermore, the configuration file may for example comprise instructions to retrieve vehicle operations plan data and multiple scripts from the fourth repository 312 for example scripts relating to aircraft specific weight & balance calculations or performance calculations to be executed by the client application 517 for example by the calculation module 721 based on the retrieved vehicle operations plan data. The central operations management platform 101 further comprises a database update module 313 connected to bus 109 configured for updating at predetermined time intervals the data stored in each of the database module repositories 105, 106, 107, 312 with data retrieved from at least one third party information source 314 such as a departure control system (DCS), a fueler, a weather forecaster, a flight plan generator and the like. The database update module 313 has the advantage of providing the database module 104 with up-to-date data from content specific third party providers 314. For example a weather forecasting third party 314 can provide the fourth repository 312 of the database module 104 with up-to-date weather data associated to a given geographical location at a given time period linked in the fourth repository 312 to journey legs having a trajectory between its origin and destination at the time of the journey corresponding to the geographical location at the given time period of the weather data. The third party providers 314 are operatively coupled to the central operations management platform 101 and to the database module 104 through the communication network 103. The database update module 313 is configured for updating the data stored in the database module 104 at predetermined time intervals for example calculated individually for each type of data stored in each of the database module repositories 105, 106, 107, 312 according to an assigned time-of-expiration identifier. Additionally, the database update module 313 is configured for updating the different data types at the request of the user. FIG. 10 shows an interactive update button 1026 enabling the qualified registered user to manually request the update of the weather data in addition to the automatic updating of the data at regular time intervals. According to an embodiment of the present invention, the notification module 111, in response to extracting changes made to the vehicle operations plan, updates the data in the database module 104 accordingly. In the case of a pilot adapting user modifiable input parameters relating to the flight route that was planned and that was presented to him in his vehicle operations planning tool, for example by changing the flight altitude for example based upon static data presented to the pilot such as weather data indicating unfavourable weather conditions at the initial flight plan altitude, updating the initial flight plan data in the database module 104 to the adapted flight plan.

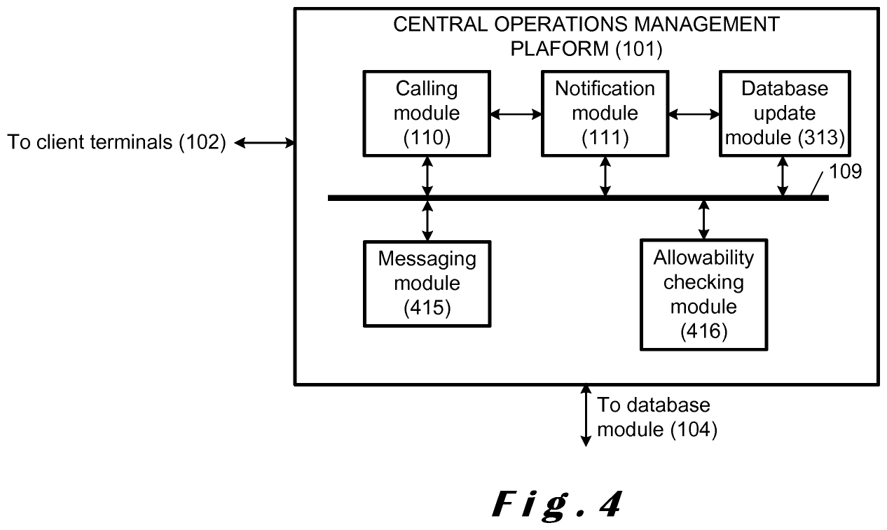

FIG. 4 shows the central operations management platform of FIG. 3, which may be further provided with a messaging module 415 and an allowability checking module 416 coupled to bus 109. The user messaging module 415 enables the qualified registered users defined in the list of the first repository 105 for selectively exchanging communication messages via the client application 517 for example running on each of the client terminals 102. The user messaging module 415 has the advantage that qualified registered users for example linked to each other by the journey leg and transport vehicle as defined in the second repository 106 can communicate in near-real time with each other for example in order to confirm or discuss the changes made to the user modifiable input parameters. The messaging module 415 may further be configured for allowing the exchange of messages between qualified registered users across the system 100, independently of whether they are linked to the same journey leg or not. For example, a pilot may exchange messages through the messaging module 415 with another pilot of a different transportation vehicle. The allowability checking module 416 may be configured, for example upon the notification module 111 extracting the values of the user modifiable input parameters, for checking the allowability of values assigned to the vehicle operations plan with respect to at least one of: regulations imposed by the type of transport vehicle stored in a regulations database for example airline policies restricting fuel consumption, user qualification stored in the first repository 105 associated to the qualified registered user for example a qualified registered user being unauthorised to perform certain vehicle operations and technical rules technically imposed on the transport vehicle for the given journey leg stored in a technical rules database for example user modifiable input parameters being incompatible with each other or against technical regulations such as ordering a lack of fuel in respect to the given transport vehicle and journey leg. The system provided with an allowability checking module 416 has the advantage of increasing the safety of the system as the changes made by the qualified registered user to the user modifiable input parameters are checked for example before the transmission of notifications of change and associated operational tasks to other qualified registered users by the notification module. The allowability checking module 416 may also prompt the notification module 111 to send allowability notifications to qualified registered users linked to the journey leg and transport vehicle in the second database that are capable of checking the allowability of the changes made to the vehicle operations plan made by a qualified registered user. The allowability checking module 416 may for example be configured for, in the case of a pilot adapting user modifiable input parameters relating to the flight route that was planned and that was presented to him in his vehicle operations planning tool, for example by changing the flight altitude for example based upon static data presented to the pilot such as weather data indicating unfavourable weather conditions at the initial flight plan altitude, notifying the flight dispatcher in order to get his approval of allowability before further sending notifications associated to operational tasks to qualified registered users or further updating the data in the database module 104 for example before committing the database module 104 to store and use the updated flight route.

FIG. 5 shows a client terminal 102 as presented in FIGS. 1 and 3, provided with the client application 517 preinstalled on the client terminal 102 configured for generating the vehicle operations planning tool and displaying it to the qualified registered user through a graphical user interface (GUI) 519. Alternatively the client application 517 is provided in a remote server, in which case the application 517 may be accessed via an internet browser on the client terminal 102. Additionally, the client terminal 102 is provided with a communication interface 518 configured for interfacing the client application 517 preinstalled on the client terminal 102 and the central operations platform 101 through the communication network 108.

FIG. 6 shows the client terminal 102 of FIG. 5 wherein the client application 517 is provided with a validity module 620. Each of the different types of data stored in each of the repositories of the database module 104 is assigned a unique time-of-expiration identifier indicating the time period for which the data is valid. The assignment of a unique time-of expiration identifier to each of the different types of data, more specifically to every data entry in each of the repositories of the database module 104 has the advantage of enabling to determine the age and validity of the data. The data validation module 620 comprised in the client application 517 is configured for determining, based on the time-of-expiration identifier, the validity of the data displayed via the GUI 519 to the client terminal 102 of the qualified registered user. The data validation module 620, upon detecting that invalid and/or incomplete data is displayed on the vehicle operations planning tool through the GUI 519 of the client terminal 102, for issuing an alert signal to the qualified registered user indicating the type of data that needs be updated. As an illustration, the vehicle operations planning tool 800 shown in FIGS. 9 and 10 show the vehicle operations planning tool 800 of a qualified registered user wherein the vehicle operations planning tool 800 indicates in an update notification tab 927 to the qualified registered user the availability and necessity to update some of the vehicle operations plan data.

FIG. 7 shows the client terminal 102 of FIG. 6 wherein the client application 517 is provided with a calculation module 721 configured for calculating, based on data forwarded by the calling module 110 such as a part of the vehicle operations plan data and calculation scripts linked to the configuration file, the initial values of at least some of the set of user modifiable input parameters and static data of the vehicle operations plan provided to the qualified registered user via the vehicle operations planning tool. The calculation module 721 is for example configured for generating an estimated amount of fuel required for a given journey leg on a given transport vehicle based for example on static data retrieved from the fourth repository 312 for example providing the calculation module 721 with expected weather forecasts, transport vehicle loading and transport vehicle performance calculation rules associated to the selected journey leg and transport vehicle.

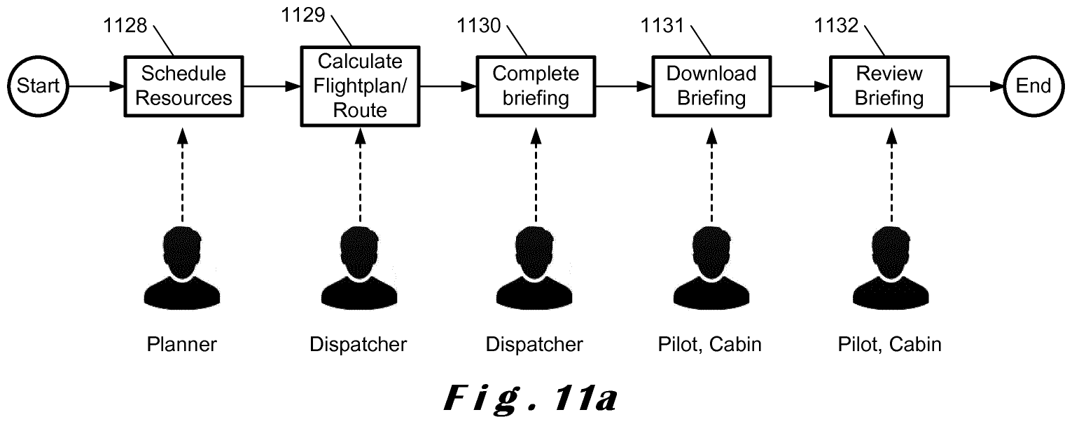

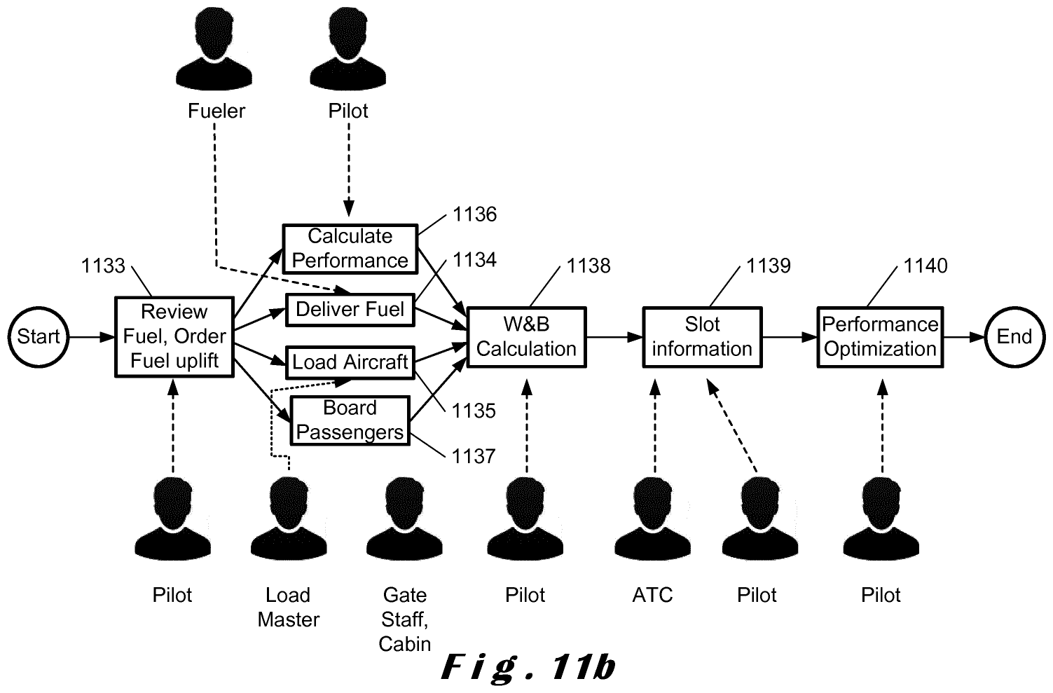

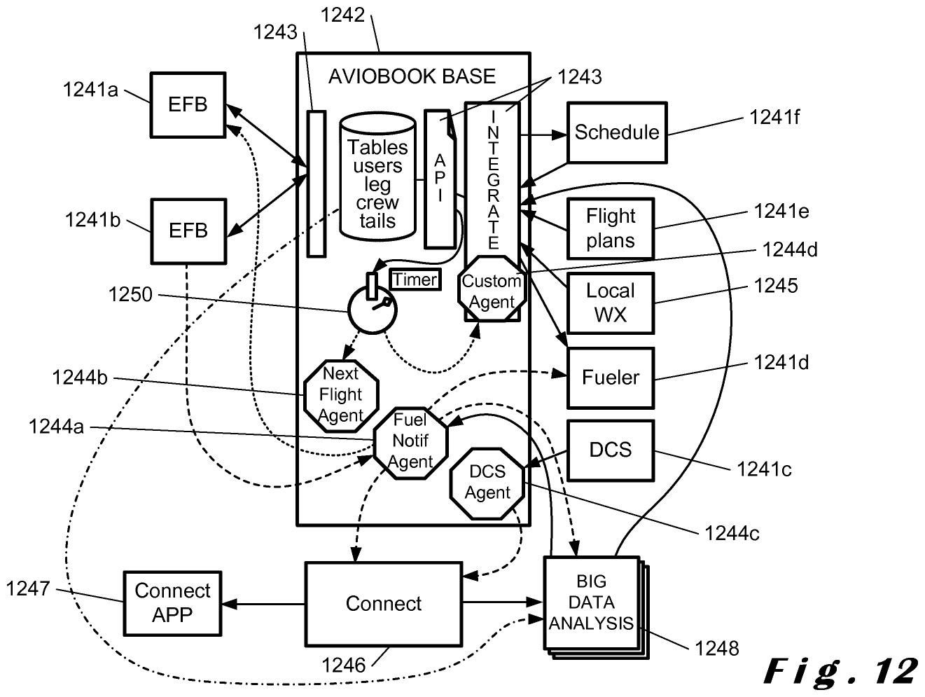

FIGS. 11a and 11b shows examples of the operation of system 100. In FIG. 11a the workflow of a preparation of a vehicle operation plan of a flight is shown. More specifically FIG. 11a shows the workflow for an office preparation of the vehicle operation plan. An office preparation relates to the vehicle operations planning taking place before the in-vehicle preparation i.e. before the pilot has entered the airplane. In FIG. 11a a number of different qualified registered users i.e. a planner, a dispatcher and a pilot/cabin crew connect to the system 100 in order to review and/or adapt the vehicle operations plan for a given transport vehicle on a given journey leg. The office preparation usually starts with a planner who schedules the resources i.e. schedules the aircraft for a given journey leg as is shown in step 1128. This step usually takes place several months before departure. The planner for example acts as an administrator and updates the second repository 106 by adding a new journey leg with a linked crew of qualified registered users. A notification of this addition of a new journey leg is send to a dispatcher responsible for calculating a flight plan/flight route for the journey leg. The dispatcher connects to the system 100 and proceeds to calculating the flight plan/flight route as shown in steps 1129. As time goes by, the dispatcher updates the vehicle operations plan for the journey leg by completing the briefing in the vehicle operations plan for example with additional notes for example on departure runway or flight departure time modifications as shown in step 1130, after which a notification will be send to the pilot and crew linked to the journey leg. Shortly before the flight, the crew, i.e. the cabin crew and the ground crew, and the pilot will connect to the system 100 from where they can download the complete dispatcher briefing for their review as shown in steps 1131 and 1132. FIG. 11b focuses on the workflow of the in-vehicle preparation of the vehicle operations i.e. the planning of vehicle operations merely a few hours before departure for example when the pilot has entered the aircraft. As in FIG. 11a, several qualified registered users interact via system 100 in order to view or change the vehicle operations plan. In-vehicle preparation usually starts with a pilot reviewing the estimated fuel levels calculated by the client application 517 based on received static data such as weather data and the flight route. The pilot, based on his expertise and for example based on communication messages received in real-time from pilots flying the same journey leg O&D as the planned journey leg O&D indicating for example a flock of birds at a given location or for example based on historical notifications received from qualified registered users having used the same aircraft in the past for example indicating an overconsumption in fuel for that given aircraft, could adjust the fuel levels and order a fuel uplift as is shown in step 1133. The pilot having made the changes to the vehicle operations plan, triggers the notification module 111 to send notifications associated to personalized operational tasks to linked qualified registered users such as the fueler delivering the requested fuel uplift as shown in step 1134, the load master rebalancing the aircraft load in function of the added fuel load as shown in step 1135, the pilot recalculating the required aircraft performances for example the required take-off speed as shown in step 1136 and the gate staff and cabin crew allowing the passengers to board as shown in step 1137. Upon the linked qualified registered users i.e. the fueler, the load master, the gate staff, the cabin crew and the pilot, having performed their operational task, the notification module 111 sends a notification to the pilot to recalculate the weight and balance of the aircraft for final validation as shown in step 1138. Upon weight and balance calculation being validated by the pilot, a notification is send to the pilot and the air traffic control (ATC), requesting the allocation of a take-off slot i.e. which runway to be taken for take-off, as shown in step 1139. Based on the notification of the correct slot information to the pilot, a final performance optimization is performed by the pilot before departure for example taking into account runway data such as runway wetness and runway length, as shown in step 1140.

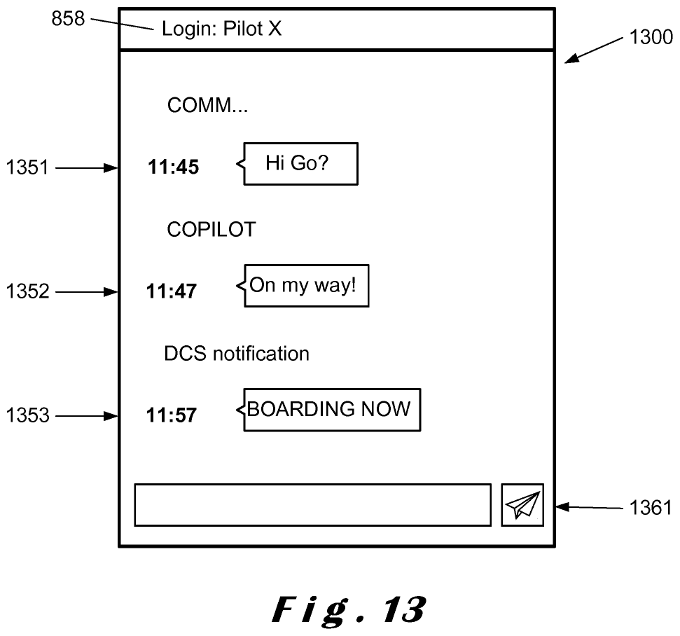

FIG. 12 shows an example of the system 100. FIG. 12 shows a plurality of client terminals 1241a, 1241b, 1241c, 1241d, 1241e, 1241f each associated to a qualified registered user, more specifically associated to respectively a first electronic flight bag (EFB), a second EFB, a departure control system (DCS), a fueler, a flight planner and a flight scheduler. The plurality of client terminals are connected to the central operations platform here referred to as Aviobook Base™ 1242, through a communication network and via specific integration interfaces operating as the calling module 1243. The central operations platform 1242 comprises a database module 1249 storing data provided by the client terminals 1241 and by third party data providers such as a weather data provider 1245. The central operations platform 1242 further comprises a plurality of notification modules 1244a, 1244b, 1244c, 1244d, each dedicated to notifying a specific user qualification type of the linked qualified registered users, more specifically respectively dedicated to notifying the fueler, the flight planner, the DCS and a customizable qualified registered user such as a notification module customizable by an airline company to notify pilots on their performance based on a measurement of their duty cycles. The central operations platform 1242 further comprises a timer module 1250 configured for monitoring the validity or due-date of the data in the database module 1249 for example based on a unique time-of-expiration identifier associated to every data entry in the database module 1249 indicating the validity of the data or the deadline within which a qualified registered user must update or work on the data, and further configured for triggering the notification modules 1244 to send update-notifications to the client terminals 1241 such that client terminals 1241 can update or work on the data accordingly. The timer module 1250 is further configured for monitoring the validity of the data in the database module 1249 for example based on a unique time-of-expiration identifier associated to every data entry in the database module 1249 indicating the validity of the data and further configured for triggering the third party data provider 2145 for updating the data in the database module 1249 accordingly. The central operations platform 1242 further comprises a messaging module indicated as ‘connect’ 1246 which comprises a ‘connect application’ 1247 through which the qualified registered users can communicate with each other. The messaging module 1247 further comprises a big data analysis module 1248 configured for running a machine learning process on the received user messages in order to extract information that might be worth integrating for example as a notification in the vehicle operations plan of a set of journey legs. As an illustration, the big data analysis module 1248 is configured for analysing the incoming user messages and extracting the flight journey referred to in the message as well as a keyword such as ‘birds’. The big data analysis module 1248 upon identifying on multiple occasions the keyword ‘birds’ in messages relating to the same journey leg O&D, may be configured for integrating a notification to all vehicle operations plans relating to that journey leg O&D indicating a danger for birds on the flight route.

FIG. 13 shows an example of a client terminal GUI 1300 wherein the client application displays how the exchange of messages between qualified registered users via the messaging module may be presented to the user. As an illustration FIG. 13 shows the exchange of messages between two qualified registered users with respective user qualification types commander (COMM) 1351 and co-pilot (COPILOT) 1352 on a client application associated to a registered qualified user logged in on the system such as a pilot named ‘X’ 858. The qualified registered user logged in to the client application can communicate with other registered users by typing messages into a messaging box 1361. Additionally, a boarding notification 1353 received from the notification module 111 has been illustrated. Upon airport personnel such as personnel in charge of a departure control system (DCS) acting as a qualified registered user changing the vehicle operations plan by indicating that boarding has started for a particular journey leg, the notification module 111 may transmit the boarding notification 1353 to the GUI 1300 of the concerned linked qualified registered users of the journey leg.

### FIGURE REFERENCES

system 100
central operations management platform 101
client terminals 102
(database module) communication network 103
database module 104
first repository 105
second repository 106
third repository 107
(client) communication network 108
Bus 109
calling module 110
notification module 111
fourth repository 312
database update module 313
third party database 314
messaging module 415
allowability checking module 416
client application 517
communication interface 518
graphical user interface (GUI) 519
validity module 620
calculation module 721
Vehicle operations planning tool GUI 800
set of journey legs 857
Login information panel 858
Journey legs loading box 862
user modifiable input parameters 922
static data 924
notification tab 925
return button 956
weather tab 955
fuel tab 954
vehicle operations plan tab 959
interactive update button 1026
weight tab 1060
weather charts 1062
update notification tab 927
client terminals 1241
central operations platform 1242
calling module 1243
notification modules 1244
third party data providers 1245
messaging module 1246
‘connect application’ 1247
big data analysis module 1248
database module 1249
timer module 1250
message exchange GUI 1300
commander (COMM) registered user 1351
co-pilot (COPILOT) registered user 1352
boarding notification 1353
messaging box 1361

1. A system for managing the operations of a commercial transport vehicle for a selected journey leg, the system comprising:
a central operations management platform operatively coupled, via a communications network, to a database comprising
a first repository comprising a list of registered users, each associated with a user security identifier and a qualification user type at least defining the role, authorization level, and type of vehicle operations assigned to each qualified registered user,
a second repository comprising a set of journey legs, each associated with a plurality of qualified registered users from the first repository and a transportation vehicle, and
a third repository comprising a plurality of vehicle configuration files each associated with a journey leg from the second repository and a predetermined qualification user type from the first repository, each configuration file defining at least a set of configuration settings for a vehicle operation plan; and
a plurality of client terminals each operatively coupled, via a communication network, to the central operations management platform, each client terminal being configured for running a client application arranged for providing to a qualified registered user of a predetermined qualification user type from the first repository, via a Graphic User Interface (GUI) of the client terminal, a vehicle operations planning tool arranged for interacting with the qualified registered user for the preparation of a vehicle operations plan for a selected journey leg, the vehicle operations planning tool being configured for providing to the qualified registered user an interactive vehicle operations plan comprising at least a set of user modifiable input parameters relating to the vehicle operations of the specific commercial transport vehicle associated with the selected journey leg and qualification user type, which user modifiable input parameters of the vehicle operation plan are configured based on the selection of at least one configuration file from the third repository;
wherein the central operations management platform comprises
a calling module configured, in response to receiving from a client terminal a user request for preparing a vehicle operations plan, for retrieving from respectively the first and second repositories the user security identifier and the journey legs associated with the qualified registered user of the client terminal, the calling module being configured for forwarding the retrieved journey legs to the client application of the client terminal issuing the user request to be displayed to the qualified registered user for the selection of a journey leg, the calling module being configured, in response to receiving a selection of a journey leg from the client application, for retrieving at least one corresponding configuration file from the third repository associated with the selected journey leg and the qualification type of the qualified registered user, which at least one configuration file is forwarded together with at least the user modifiable input parameters to the client application of the client terminal for at least configuring the set of user modifiable input parameters of the vehicle operations plan provided to qualified registered user; and
a notification module configured, in response to receiving a vehicle operations plan from a client terminal, for extracting the values of the user modifiable input parameters of the vehicle operation plan and accordingly prepare at least one notification comprising information on the extracted values, which at least one notification is to be the selectively forwarded, via a notification server, to at least one of the remaining qualified registered users, indicated in the second repository as being associated with the selected journey leg.

2. The system of claim 1, wherein the notification module is configured for selecting the qualified registered users to be notified based on at least the qualification user type of each qualified registered user associated with the selected journey leg and the values assigned by the qualified registered user to the user modifiable parameters of the vehicle operations plan.

3. The system of claim 1, wherein the notification module is configured for personalizing the notifications issued to each of the selected qualified registered users according to their qualification user type.

4. The system of claim 3, wherein the notification module is configured for selecting the notifications to be pushed to each of the selected qualified registered users from a user notification Look Up Table (LUT) stored in the first repository, which LUT comprises a set of instructions indicating the type of notifications to be pushed to each qualified registered user according to their qualification user type and type of changes made to the vehicle operations plan.

5. The system of claim 4, wherein the notification issued comprises instructions for executing at least one operational task.

6. The system of claim 5, wherein the notification module is configured for deriving the at least one operational task from at least the values assigned to the set of user modifiable input parameters of the received vehicle operation plan.

7. The system of claim 4, wherein the notification module is configured for deriving the at least one user operational task from at least historical information associated with the selected journey leg and transportation vehicle, wherein the historical information are retrieved from a historical information database.

8. The system of claim 1, wherein the notifications issued by the notification module to be displayed on the GUI of the client terminals of each of the selected qualified registered users.

9. The system of claim 1, wherein the database comprises a fourth repository storing a set of first data structures each storing journey information associated with a predetermined journey leg, and a set of second data structures each storing configuration information of a predetermined transportation vehicle, wherein each first and second data structures are associated with a user qualification type and a journey leg from respectively the first and second repositories.

10. The system of claim 9, wherein the calling module is configured for retrieving from the fourth repository the first and second data structures associated with the selected journey leg and qualification type of the qualified registered user, wherein the retrieved first and second data structures are forwarded to the qualified registered user together with the selected configuration file.

11. The system of claim 1, wherein each of the different types of data stored in each of the repositories of the database is assigned a unique time-of-expiration identifier indicating the time period for which the data is valid.

12. The system of claim 11, wherein the client application comprises a data validation module configured for determining, based on the time-of-expiration identifier, the validity of the data displayed via the GUI to the client terminal of the qualified registered user.

13. The system of claim 12, wherein the data validation module is configured, upon detecting that invalid and/or incomplete data is displayed on the GUI of the client terminal, for issuing an alert signal to the qualified registered user indicating the type of data that needs be updated.

14. The system of claim 13, wherein the data validation module is configured for preventing the user for preparing the vehicle operations plan while the alert signal is displayed on the GUI of the client terminal.

15. The system of claim 1, wherein the central operations management platform comprises a database update module configured for updating at predetermined time intervals the data stored in each of the database repositories with data retrieved from at least one third party database.

16. The system of claim 1, wherein the client application comprises a calculation module configured for calculating, based on data forwarded by the calling module, the initial values of at least some of the set of user modifiable input parameters of the vehicle operations plan provided to the qualified registered user via the vehicle operations planning tool.

17. The system of claim 1, wherein the central operations management platform comprises a user messaging module configured for enabling the qualified registered users defined in the list of the first repository for selectively exchanging communication messages via the client application running on each of the client terminals.

18. The system of claim 1, wherein the central operations management platform comprises a user registration module configured for registering, at the request of a qualified registered user having an appropriate authorization level, an additional user in the list of qualified registered users of the first and second repositories of the database module, the user registration module being configured for selectively assigning a registration expiration identifier to the additional user, indicating a predetermined period for maintaining the additional user in the list of qualified registered users.

19. The system of claim 1, wherein the system comprises at least one administrator terminal operatively coupled to the database module, the administrator module comprising a GUI arranged for allowing an administrator user to access and to adapt the data stored in the database module.

20. The system of claim 1, wherein the commercial vehicle transport is selected from a group consisting of an aircraft, train, bus, ship and truck.

21. The system of claim 1, wherein the qualified registered user is selected from a group of users consisting of a pilot, crew member, ground operating staff, airline operator, dispatcher, and an air traffic controller.

22. The system of claim 1, wherein at least one of the plurality of client terminal is part of an electronic device comprising an Electronic Flight Bag (EFB) software application.

23. The system of claim 1, wherein the client application is associated with the qualification user type of the qualified registered user.

24. A method for managing the operations of a commercial transport vehicle for a selected journey leg, the method comprising:
providing a central operations management platform operatively coupled, via a communication network, to a database comprising
a first repository comprising a list of registered users, each associated with a qualification user type at least defining the role, authorization level, and type of vehicle operations assigned to each qualified registered user,
a second repository comprising a set of journey legs of a transportation vehicle, wherein each journey leg is associated with a plurality of qualified registered users from the first repository, and
a third repository comprising a plurality of vehicle configuration files each associated with a journey leg from the second repository and a predetermined qualification user type from the first repository, each configuration file defining at least a set of configuration settings for a vehicle operation plan;
providing a plurality of client terminals each operatively coupled, via a communication network, to the central operations management platform, each client terminal being provided with a client application configured when running for executing the steps of:
providing to a qualified registered user from the first repository having a predetermined qualification user type, via a Graphic User Interface (GUI) of the client terminal, a vehicle operations planning tool configured for providing to the qualified registered user a vehicle operations plan comprising at least a set of user modifiable input parameters relating to the vehicle operation settings of the specific commercial transport vehicle associated with the selected journey leg, which user modifiable input parameters of the vehicle operation plan are defined based on the selection of at least one configuration file from the third repository; and
preparing the vehicle operations plan for the selected journey leg;
wherein the step of preparing the vehicle operations plan comprises:
in response to receiving at the central operation management platform a user request for preparing a vehicle operations plan, retrieving by means of a calling module from respectively the first and second repositories the user qualification type and the journey legs associated with the qualified registered user of the client terminal used to issue the user request;
forwarding by the calling module the retrieved journey legs to the client application of the client terminal used to issue the user request to be displayed to the qualified registered user, via the GUI, for the selection of a journey leg,
wherein the calling module is configured, in response to receiving a selection of a journey leg, from the client application, for performing the steps of:
retrieving by the calling module at least one corresponding configuration file from the third repository associated with the selected journey leg and the qualification type of the qualified registered user; and
forwarding by the calling module the retrieved at least one configuration file together with at least the user modifiable input parameters to the client application of the client terminal for at least configuring the set of user modifiable input parameters of the vehicle operations plan provided to qualified registered user; and
for selectively notifying by a notification module at least one the remaining qualified registered users, indicated in the second repository as being associated with the selected journey leg, wherein the notification module is configured, in response to receiving a vehicle operations plan from a client terminal, for at least performing the steps of:
extracting from the vehicle operation plan the values assigned to the user modifiable input parameters,
preparing at least one notification comprising information on the extracted values, and
selectively forwarding the at least one notification, via a notification server, to at least one of the remaining qualified registered users, indicated in the second repository as being associated with the selected journey leg.

25. The method of claim 24, wherein the step of preparing the vehicle operations plan comprises:
updating vehicle and journey leg related data presented to the user;
modifying the value of at least one of the input parameters of the vehicle operation plan; and
committing the vehicle operations plan for execution to the central operations management platform.

26. A computer readable medium comprising executable instructions that when executed by one or more computing devices performs the steps of the method of claim 24.
